(19) United States
(12) Patent Application Publication
(10) Pub. No.: US 2016/0104207 A1
(43) Pub. Date: Apr. 14, 2016

(54) ADVERTISING CAMPAIGN CONVERSION SYSTEMS AND METHODS

(71) Applicant: Papaya Mobile, Inc., Beijing (CN)

(72) Inventors: Kunliang Zhao, Beijing (CN); Xiao Chen, Beijing (CN); Wenjie Qian, Beijing (CN)

(21) Appl. No.: 14/512,398

(22) Filed: Oct. 11, 2014

(51) Int. Cl. G06Q 30/02

(52) U.S. Cl. CPC G06Q 30/0275

(57) ABSTRACT

Aspects described herein are directed towards methods, systems, and non-transitory computer-readable mediums for converting advertisement pricing and tracking advertisements between different advertising models or campaign types. Aspects of the disclosure include receiving a request for an advertisement to display on a first computing device in a first campaign type where the request includes information about the potential viewer. In response to request, an estimated advertisement value in a second campaign type for an advertising campaign can be determined based on at least one advertisement value in the first campaign type and an advertisement history of the advertising campaign. A bid price for displaying an ad to the potential viewer may be determined based on the estimated advertisement value in the second campaign type. Once the bid price is accepted, an advertisement from the advertising campaign may be transmitted to the first computing device.

### FIELD

Aspects described herein relate generally to advertising campaign conversion systems and methods. More specifically, aspects described herein relate to converting between different types of advertising campaigns.

### BACKGROUND

In advertising on computing devices, advertisers can pay for advertisements (ads) depending on the level of user interaction with the advertisement. In a cost-per-click (CPC) advertising model, advertisers pay only for advertisements that a user clicks or selects. Another advertising model is the cost-per-mile (CPM) advertising model, the advertiser pays a specific price or bid price for every 1,000 impressions or advertisement displays on computing devices. Yet another advertising model is the cost-per-install (CPI) model which may also be called a cost-per-acquisition (CPA) model where the advertiser pays only for those advertisements which directly lead to a user performing a defined action such as installing an advertised application or purchasing products from the advertised website or company. Each advertising model has different benefits and risk/reward returns. As a result, the different advertising models do not have a direct cost and return value correlation, and costs and potential returns of different campaigns can not easily be translated between different platforms.

### SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below.

To overcome limitations in the prior art described above, and to overcome other limitations that will be apparent upon reading and understanding the present specification, aspects described herein are directed towards methods, systems, and non-transitory computer-readable mediums for converting advertisement pricing and tracking advertisements between different advertising models or campaign types. Aspects described herein provide the ability to automatically convert between advertising campaigns based on different advertising models to enable advertisers or users to run one type of campaign on a platform that supports a different type of campaign and to more easily manage different advertising campaigns.

Aspects of the disclosure include receiving a request for an advertisement to display on a first computing device in a first campaign type where the request includes information about the potential viewer. In response to request, an estimated advertisement value in a second campaign type for an advertising campaign can be determined based on at least one advertisement value in the first campaign type and an advertisement history of the advertising campaign. A bid price for displaying an ad to the potential viewer may be determined based on the estimated advertisement value in the second campaign type. Once the bid price is accepted, an advertisement from the advertising campaign may be transmitted to the first computing device.

In another aspect, the estimated advertisement value may be determined based on a normal distribution function N(μ, σ), where μ=an average CPM value (aCPM) and σ=0.1*aCPM. The average CPM value may be determined based on the following equation:

aCPM=10³*(α*CTR*IR*CPI+βΣ(η(i)*d(i))),
where: α+β=1,
   α and β=manually adjusted weights,
   CTR=click-through rate of the advertising campaign,
   IR=install rate of the advertising campaign,
   CPI=cost-per-install price for the advertising campaign
   d(i)=ith dimension value, and
   η(i)=weighting for the ith dimension.
      The click transfer rate (CTR), an install rate (IR), and a cost-per-install (CPI) may be determined based on the advertising history of the advertising campaign such as log history maintaining the number of clicks, installs, and/or impressions of the advertisement.

In some aspects, the estimated advertisement value may be used in automatically bidding to display an advertisement from the advertising campaign to the potential viewer in the ad request.

These and additional aspects will be appreciated with the benefit of the disclosures discussed in further detail below.

### BRIEF DESCRIPTION OF THE DRAWINGS

A more complete understanding of aspects described herein and the advantages thereof may be acquired by referring to the following description in consideration of the accompanying drawings, in which like reference numbers indicate like features, and wherein:

FIG. 1 depicts an illustrative computer system architecture that may be used in accordance with one or more illustrative aspects described herein.

FIG. 2 depicts an illustrative advertisement platform conversion system in accordance with one or more illustrative aspects described herein.

FIG. 3 depicts an illustrative system flow diagram in accordance with one or more illustrative aspects described herein.

### DETAILED DESCRIPTION

In the following description of the various embodiments, reference is made to the accompanying drawings identified above and which form a part hereof, and in which is shown by way of illustration various embodiments in which aspects described herein may be practiced. It is to be understood that other embodiments may be utilized and structural and functional modifications may be made without departing from the scope described herein. Various aspects are capable of other embodiments and of being practiced or being carried out in various different ways.

It is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. The use of the terms “mounted,” “connected,” “coupled,” “positioned,” “engaged” and similar terms, is meant to include both direct and indirect mounting, connecting, coupling, positioning and engaging.

Aspects of the disclosure described herein relate to methods, systems, and non-transitory computer-readable mediums for converting and tracking advertisements between different advertising models or campaign types. More specifically, aspects of the disclosure may relate to converting between advertising models used in advertising on mobile device platforms such as CPI/CPA campaigns and CPC/CPM campaigns and tracking advertisements for the entire campaign. Aspects of the disclosure may analyze the effectiveness of advertising campaigns and adjust bidding prices and advertising strategies for ad placements.

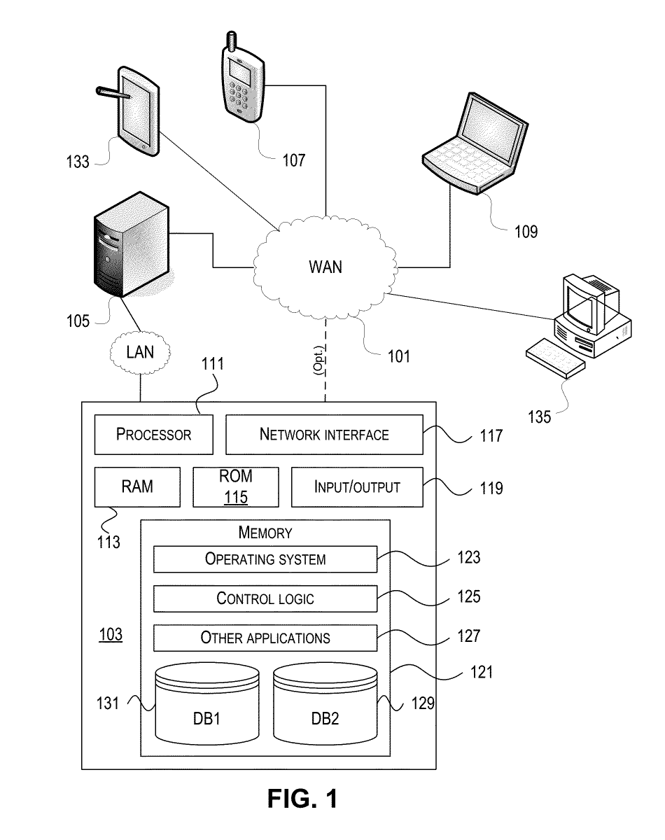

Computer software, hardware, and networks may be utilized in a variety of different system environments, including standalone, networked, remote-access (aka, remote desktop), virtualized, and/or cloud-based environments, among others. FIG. 1 illustrates one example of a system architecture and data processing device that may be used to implement one or more illustrative aspects described herein in a standalone and/or networked environment. Various network nodes 103, 105, 107, 109, 133, and 135 may be interconnected via a wide area network (WAN) 101, such as the Internet. Other networks may also or alternatively be used, including private intranets, corporate networks, LANs, metropolitan area networks (MAN) wireless networks, personal networks (PAN), and the like. Network 101 is for illustration purposes and may be replaced with fewer or additional computer networks. A local area network (LAN) may have one or more of any known LAN topology and may use one or more of a variety of different protocols, such as Ethernet. Devices 103, 105, 107, 109, 133, and 135 and other devices (not shown) may be connected to one or more of the networks via twisted pair wires, coaxial cable, fiber optics, radio waves or other communication media.

The term “network” as used herein and depicted in the drawings refers not only to systems in which remote storage devices are coupled together via one or more communication paths, but also to stand-alone devices that may be coupled, from time to time, to such systems that have storage capability. Consequently, the term “network” includes not only a “physical network” but also a “content network,” which is comprised of the data—attributable to a single entity—which resides across all physical networks.

The components may include data server 103, web server 105, and client computers 107, 109, 133, 135. Data server 103 provides overall access, control and administration of databases and control software for performing one or more illustrative aspects describe herein. Data server 103 may be connected to web server 105 through which users interact with and obtain data as requested. Alternatively, data server 103 may act as a web server itself and be directly connected to the Internet. Data server 103 may be connected to web server 105 through the network 101 (e.g., the Internet), via direct or indirect connection, or via some other network. Users may interact with the data server 103 using remote computers 107, 109, 133, 135, e.g., using a web browser to connect to the data server 103 via one or more externally exposed web sites hosted by web server 105. Client computers 107, 109, 133, 135 may be used in concert with data server 103 to access data stored therein, or may be used for other purposes. For example, from client device 107 a user may access web server 105 using an Internet browser, as is known in the art, or by executing a software application that communicates with web server 105 and/or data server 103 over a computer network (such as the Internet).

Servers and applications may be combined on the same physical machines, and retain separate virtual or logical addresses, or may reside on separate physical machines. FIG. 1 illustrates just one example of a network architecture that may be used, and those of skill in the art will appreciate that the specific network architecture and data processing devices used may vary, and are secondary to the functionality that they provide, as further described herein. For example, services provided by web server 105 and data server 103 may be combined on a single server.

Each component 103, 105, 107, 109, 133, 135 may be any type of known computer, server, or data processing device. Data server 103, e.g., may include a processor 111 controlling overall operation of the data server 103. Data server 103 may further include random access memory (RAM) 113, read only memory (ROM) 115, network interface 117, input/output interfaces 119 (e.g., keyboard, mouse, display, printer, etc.), and memory 121. Input/output (I/O) 119 may include a variety of interface units and drives for reading, writing, displaying, and/or printing data or files. Memory 121 may further store operating system software 123 for controlling overall operation of the data processing device 103, control logic 125 for instructing data server 103 to perform aspects described herein, and other application software 127 providing secondary, support, and/or other functionality which may or might not be used in conjunction with aspects described herein. The control logic may also be referred to herein as the data server software 125. Functionality of the data server software may refer to operations or decisions made automatically based on rules coded into the control logic, made manually by a user providing input into the system, and/or a combination of automatic processing based on user input (e.g., queries, data updates, etc.).

Memory 121 may also store data used in performance of one or more aspects described herein, including a first database 129 and a second database 131. In some embodiments, the first database may include the second database (e.g., as a separate table, report, etc.). That is, the information can be stored in a single database, or separated into different logical, virtual, or physical databases, depending on system design. Devices 105, 107, 109, 133, 135 may have similar or different architecture as described with respect to device 103. Those of skill in the art will appreciate that the functionality of data processing device 103 (or device 105, 107, 109, 133, 135) as described herein may be spread across multiple data processing devices, for example, to distribute processing load across multiple computers, to segregate transactions based on geographic location, user access level, quality of service (QoS), etc.

One or more aspects may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HyperText Markup Language (HTML) or Extensible Markup Language (XML). The computer executable instructions may be stored on a computer readable medium such as a nonvolatile storage device. Any suitable computer readable storage media may be utilized, including hard disks, CD-ROMs, optical storage devices, magnetic storage devices, and/or any combination thereof. In addition, various transmission (non-storage) media representing data or events as described herein may be transferred between a source and a destination in the form of electromagnetic waves traveling through signal-conducting media such as metal wires, optical fibers, and/or wireless transmission media (e.g., air and/or space). Various aspects described herein may be embodied as a method, a data processing system, or a computer program product. Therefore, various functionalities may be embodied in whole or in part in software, firmware and/or hardware or hardware equivalents such as integrated circuits, field programmable gate arrays (FPGA), and the like. Particular data structures may be used to more effectively implement one or more aspects described herein, and such data structures are contemplated within the scope of computer executable instructions and computer-usable data described herein.

Components 105, 107, 109, 133, 135 may be personal computers, mobile devices, laptop computers, tablets, or servers that include many or all of the elements described above with respect to the computing device 103. The network connections depicted in FIG. 1 include a local area network (LAN) and a wide area network (WAN), but may also include other networks. The components 105 may be connected to the LAN through a network interface or adapter. When used in a WAN networking environment, components 105, 107, 109, 133, 135 may include a modem or other wide area network interface for establishing communications over the WAN, such as computer network (e.g., the Internet). It will be appreciated that the network connections shown are illustrative and other means of establishing a communications link between the computers may be used. Components 107, 109, 133 may also be mobile terminals (e.g., mobile phones, smartphones, personal digital assistants (PDAs), notebooks, etc.) including various other components, such as a battery, speaker, and antennas (not shown).

Aspects described herein may also be operational with numerous other general purpose or special purpose computing system environments or configurations. Examples of other computing systems, environments, and/or configurations that may be suitable for use with aspects described herein include, but are not limited to, personal computers, server computers, hand-held or laptop devices, multiprocessor systems, microprocessor-based systems, set top boxes, programmable consumer electronics, network personal computers (PCs), minicomputers, mainframe computers, distributed computing environments that include any of the above systems or devices, and the like.

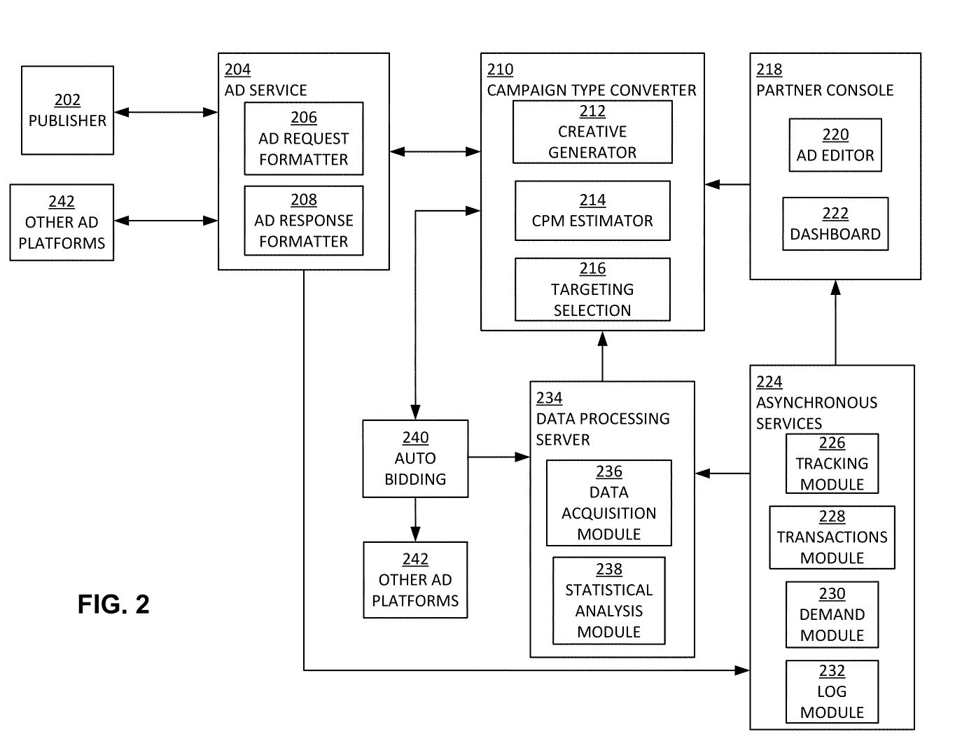

FIG. 2 illustrates an example advertising system 200 in accordance with aspects described herein. Each server may represent one or more servers and each module may be implemented using one or more servers. The connections between the different servers and/or modules may be bidirectional, and the arrows in FIG. 2 may represent general data flow between servers and/or modules in the system 200. The system 200 may include publishers 202, an advertisement (ad) service server 204, a campaign type converter 210, a partner console server 218, an asynchronous services server 224, a data processing server 234, an automatic bidding server 240, and other advertisement platforms 242. The components 204-240 of system 200 may be implemented on one or more data servers 103 and/or web servers 105. Publishers 202 may be implemented on one or more client computers 107, 109, 133, 135, or data servers 103 and/or web servers 105 of another ad platform or network.

Publisher 202 may include one or more platforms or parties who display advertisements in exchange for payment or similar services from another publisher. For example, publishers may include application developers or other advertising networks who provide space and/or the opportunity to display an advertisement to a user or potential customer. Publishers 202 may support campaigns different than one being used by a current advertiser. For example, the current advertiser may be running a CPI or CPA advertising campaign, and other ad platforms or publishers 202 may be providing bid prices for advertising space on a per-click basis or for a CPC or CPM campaign type. The system 200 may convert the advertiser's CPI or CPA advertising campaign to a CPC or CPM campaign by estimating an appropriate CPM bid value based on various factors (e.g., probability that a user will click or install the ad) and the CPI advertising campaign parameters as will be described in more detail herein. Similarly, other advertising platforms or advertising partners may be running a CPI or CPA campaign and request a CPM or CPC campaign for publishers 202 of the system 200. To run the CPI/CPA campaign of other ad platforms or partners on system 200, the system 200 may convert the CPI/CPA campaign type to a CPM/CPC campaign type.

Publisher 202 and/or publishers of other ad platforms 242 may send advertisement requests to ad service server 204 to request creative content or advertisements to place in the publisher's advertising space which may be in the publisher's application (e.g., mobile device application). The advertisement request may include request information or dimension information such as demographics of potential ad viewers (e.g., user internet protocol (IP) address, user country, user language, user location (e.g., latitude, longitude), user mobile carrier, user device information (e.g., brand, model, operating system (OS), operation system version, user gender, user age, user's unique identifier, user application identifier, user application domain), advertisement size or dimensions (e.g., advertisement container weight, advertisement height, advertisement container screen position) and/or type (e.g., image, banner, video, pop-up, splash screen) of creative content that may be displayed within the publisher's application or other ad platform 242. Examples of user application domains may be facebook.com for the Facebook mobile application, twitter.com for the Twitter mobile application, netflix.com for the Netflix mobile application, etc.

Ad service server 204 may receive and process ad requests from publishers 202 and respond to the ad requests. Ad service server 204 may include an ad request parser and formatter 206 and an ad response formatter 208. Ad request formatter 206 may receive ad requests in a first format and translate the ad requests into a format standard for the system 200. Ad request formatter 206 may associate or assign information included in the ad request to a dimension of system 200. For example, an ad request may request an advertisement to be displayed for a male user aged 30 and request that the advertisement be in the form of a banner ad with particular dimensions. The ad request parser may identify each dimension and store information obtained from the ad request as dimension information. For dimensions which the ad request does not specify, a default value may be assigned such as null. Ad request formatter 206 may generate a global unique identifier such as a transaction identifier to identify the ad through the entire ad process flow. The entire ad process flow may include events such as bidding, impression, click, install and/or other actions. The occurrence of each event may be stored in a log by a log module 232 in asynchronous services 224.

Campaign type converter 210 may receive the ad requests from ad service 204, process the ad request, and transmit an ad to ad service 204 based on the information included in the ad request. Converter 210 may include a creative generator 212, CPM estimator 214, and targeting selection module 216. Creative generator 212 may generate different advertisements based on the CPI/CPA campaign settings, target dimensions, ad type, and the requested size of the ad. For example, the advertisement may be in the form of an interstitial advertisement in English. Creative generator 212 may generate the advertisement by retrieving the advertisement image having an ad size for an interstitial advertisement and using text in English. As another example, the advertisement may be a banner ad in a particular view, landscape or portrait, in Spanish. Creative generator may retrieve the image matching the ad container size dimensions for a banner ad in the appropriate view which includes the text in Spanish. The size dimensions may be provided as height and width in terms of the number of pixels.

CPM estimator 214 can estimate appropriate CPM value and bid price for different dimensions where the estimated CPM value may be used as the bid price. The CPM may follow a Gaussian or normal distribution, and the Gaussian or normal distribution may be calculated as CPM=N(aCPM, 0.1 * aCPM) to take into account any statistical errors from a theoretical expected CPM value where the function is the normal or Gaussian distribution function N(μ, σ), μ is the mean or average, and σ is the standard deviation. The function N(μ, σ) may be

$$\frac{1}{σ \sqrt{2 π}} {e}^{- \frac{{( x - μ )}^{2}}{2 {σ}^{2}}}$$

where x is a random variable and may be the CPM value. The estimated CPM value to be used for the bid price may be generated based on the normal distribution probabilities. A random number generator which generates numbers weighted based on probabilities of the normal distribution may be used. For example, the Python standard library function random.normalvariate be used to generate the CPM value based on an average value of aCPM and a standard deviation of 0.1*aCPM.

The variable aCPM is the average CPM value which may be calculated according to the following formula:

aCPM=10³*(α*CTR*IR*CPI+βΣ(η(i)*d(i))),
where: α+β=1,
   α and β=manually adjusted weights depending on campaign and target audience,
   CTR=click-through rate,
   IR=install rate,
   CPI=cost-per-install campaign price,
   d(i)=ith dimension value, and
   η(i)=weighting for ith dimension.

Some of the values used in calculating the average CPM value may be provided by data processing server 234. The aCPM may be composed of two portions. A first portion may be calculated based on historical or logged data, and a second portion may be a predicted value based on historical data, models, and target dimensions. The first portion may be weighted using variable α, and the second portion may be weighted using the variable β. The variables α and β may be manually adjusted weights which are obtained through experimentation and/or derived from historical data such as the logs and/or based on predicted conversion rates. The values for α and β may depend on the applications used and the targeted or selected dimensions used for the ad. The variable α may be used to weight the portion of the aCPM equation which is based on historical data. As discussed herein, CTR, IR, and CPI may be based on the actual number of clicks and installations recorded or logged for an advertisement in a particular campaign in a period of time. The variable β may be used to weight the predictive portion of the equation. Specifically, Σ(η(i)*d(i)), as will be discussed in more detail herein, may provide a predictive component based on targeted dimensions for the average CPM value (aCPM). For example, the predictive component may represent a predicted click and/or conversion rate for specific target dimensions. In the beginning β may be a small value, and as more dimensions are used and more historical data is processed β may become larger. β may be increased because, as more historical data is processed, the predictive component in the aCPM calculation becomes more accurate. The variable β may have a maximum value of 0.8, and therefore, the variable α may have a minimum value of 0.2. The variable β may be calculated first, and the variable α may be determined from the calculated β value as being equal to 1−β. In other words, as the predictive component becomes more accurate, more weight may be given to the predictive component which is specific to the dimensions being targeted. The click-through rate (CTR) may be a ratio of the number of impressions of an ad and the number of clicks on the ad or a percentage of the number of impressions which lead to a user clicking on the ad. The CTR for a campaign may be determined based on the formula CTR=((campaign ad clicks)/(campaign ad impressions))*100. A default CTR value may be obtained from data processing server 234 for the particular campaign which may be in the range of 1%-15%. A user clicking on the ad may take the user to a download page where the user can download a particular application. For example, a user may click on an advertisement which causes an app store application to launch with the app store application showing the download page of the application in the advertisement. Another rate may be used to measure the ratio of the number of installations of an application to the number of clicks. For example, the rate may be in the form of a percentage determined based on IR=((install rate)/(number of clicks))*100. A default IR value may be in the range of 2% to 10%. The cost-per-install (CPI) may be the cost to the advertiser for each installation of the advertiser's application. The CPI campaign price as used in the average CPM equation may be the total amount authorized by the advertiser for the particular advertising campaign or a maximum bid authorized by the advertiser. The parameter d(i) may be a value assigned for the ith dimension, and η(i) may be a weight value for the ith dimension which are provided by statistical analysis module 238 of data processing server 234. An example calculation for the average CPM of a campaign is provided. A campaign may have a CPI campaign price of $1 and may have a CTR of 0.04. In this example, we may use countries and age of a viewer as the dimensions in evaluating the CPM value. In this instance, a may be equal to 0.8 and β may be equal to 0.2. For η(country), the value is 0.55 with a d(i) equal to 0.0015 and for η(age), the value is 0.14 with a d(i) equal to 0.0008. Using these values in the equation aCPM=10³*)α*CTR*IR*CPI+βΣ(η(i)*d(i))), the average CPM for this example is:

aCPM=10³*(0.2*0.04*0.02*1+0.2(0.55*0.0015+0.14*0.0008))=0.83

Targeting selection 216 may choose the proper targeting assembly or combination of dimensions for each advertisement based on information included in the ad request. Target categories may include countries or regions (e.g., continents, regions of countries (e.g., mid-west, mid-atlantic, northeast, southeast, central, west), user language, operating system version, device types (e.g., phones, tablets, or other devices), publisher application categories (e.g., games, business, productivity, music, finance, photography, social, health, fitness, shopping, weather, entertainment, lifestyle, etc.). For example, the ad request may include information indicating that a potential viewer of the ad is located in the United States, understands Spanish, and is using a game app on a smartphone having an Android operating system. The ad request may include coordinates of a potential viewer's location such as longitude and latitude which can be used to determine a region of a country. Based on the potential viewer information, targeting selection 216 may select an ad whose target audience is a Spanish-speaker in the U.S. using an Android based phone. Such an ad may be an ad having image text in Spanish which links to the U.S. version of an Android application store (e.g., Google Play, Amazon Appstore for Android).

Partner console 218 enables provides a console or interface for other advertising platforms or partners to access system 200 and use publishers 202 of system 200. Using partner console 218, a user can setup an advertising campaign and input settings for the campaign such as creative content which may be an advertisement in different formats (e.g., banner, interstitial, list, panel, etc.) and languages, target settings categories (e.g., countries, language, device operating system version, device type, publisher application categories, etc.). Ad editor 220 may enable the user to provide images and edit images for the creative content. Dashboard 222 of partner console 218 may enable a user to view statistics of the campaign (e.g., number of bids, number of installs, amount spent, install rate, click-through rate, fill rate). The statistics of the campaign may be total statistics for the campaign, each publisher, a country or a group of countries, operating system version, publisher application category, language, advertisement type, and/or time period. Through dashboard 222, a user can enter a highest bid price for placing an advertisement in the campaign and a daily limit for spending on ad placements. The highest bid price may be specified per publisher. For publishers, partner console 218 may be used by publishers to control the advertisements and settings for advertisements placed in the publishers' applications such as bid price, traffic allocation, etc. and to view statistics related to advertisement placements in the publisher's applications.

Asynchronous services 224 may include a tracking module 226, a transactions module 228, a demand module 230, and a log module 232. Tracking module 226 may assign a unique transaction identifier for each campaign or advertisement type and ad events are tracked according to the transaction identifier. Transactions module 228 may handle processing of the ad transaction such as charging the advertiser's account for displaying the ad and crediting the publisher's account for displaying the ad. Demand module 230 may track inventory of available ads to display. Log module 232 may store information about each ad event in an ad's life cycle. For example, the log may be in the form of a table with the life cycle of each ad being a row of data including the transaction identifier of the ad, the dimensions or characteristics of the user shown the ad, bid price, and whether the ad was an impression, clicked and/or installed.

Data processing server 234 may include a data acquisition module 236 and a statistical analysis module 238. Data acquisition module 236 may collect source data from asynchronous services 224 or use an application programming interface (API) to obtain or query for source data from other advertising platforms. Statistical analysis module 238 may use the data acquired by data acquisition module 236 to calculate various statistics including a historical conversion rate (e.g., CTR and/or IR), and a predicted conversion rate (e.g., d(i), and η(i)) which can be used by converter 210 in calculating and/or optimizing an estimated CPM. For example, statistical analysis module 238 may use the transaction identifier of the ad to obtain or aggregate data from logs relating to previous log points in the ad flow. Using the aggregate ad data from the logs, the statistical analysis module 238 can calculate a click-through rate (CTR), an install rate (IR), etc. for each campaign, dimension, and/or groups or combinations of dimensions. For dimensions or combinations of dimensions that do not appear historically and/or do not have sufficient data points in the log, the statistical analysis module 238 may use, for example, a logistic regression model to interpolate the data and estimate an install rate and/or click through rate associated with that dimension. The logistic regression model may indicate the probability that a user matching the target dimensions will click on the advertisement and/or install the advertised application. An example of using a logistic regression model to determine the probability that a user will click on an advertisement may be found in the paper “Predicting Clicks: Estimating the Click-Through Rate for New Ads” authored by Matthew Richardson, Ewa Dominowska, and Robert Ragno and presented at WWW 2007 Conference (May 8-12, 2007) held by International World Wide Web Conference Committee (IW3C2) (ACM 978-1-59593-654-7/07/0005), herein incorporated by reference in its entirety.

As another example, estimated IR and/or CTR rates may be calculated for a group or cluster of dimensions using a k-means algorithm. The k-means algorithm may be used to estimate the probability that a user with the clustered dimensions or dimensions in the group will click on the advertisement and/or install the advertised application. An example of the k-means algorithm may be found under the title “k-means clustering” on Wikipedia as published on Aug. 27, 2014, herein incorporated by reference in its entirety, which may be found at: http://web.archive.org/web/20140827195754/http://en.wikipedia.org/wiki/K-means_clustering.

The weight value η(i) of the ith dimension may also be calculated using logistic regression for a target dimension or group of target dimensions. An example of using logistic regression to calculate a weight value for a target dimension or group of target dimensions may be found in the paper “Simple and scalable response prediction for display advertising” authored by Olivier Chapelle, Eren Manavoglu, and Romer Rosales which is incorporated by reference herein in its entirety.

The dimension value d(i) may be an original value of the ith dimension. For example, the value of a geographic dimension can be a country name. Each country name may be assigned or associated with a particular value. For example, the United States may have a value of 1, and the China may have a value of 2. The values for the dimensions may be represented by a discrete vector. For example, in the discrete vector, a first value in the vector may correspond to a first country, and a second value in the vector may correspond to a second country, etc. As another example, a real number may be used as the dimension value d(i) for an age dimension. For easier calculations, the age dimension may be divided into age ranges or segments, and each age range or segment may correspond to a discrete value.

An auction type process may be used in determining which ads are displayed and the cost of displaying the ads through submitted bid prices. The bids may be controlled manually or automatically. Auto bidding 240 can receive an advertiser's maximum bid price for a CPC, CPM, or estimated CPM value and automatically bid on behalf of an advertiser in increments for displaying the advertiser's ad. An ad may be displayed once a publisher accepts a bid price.

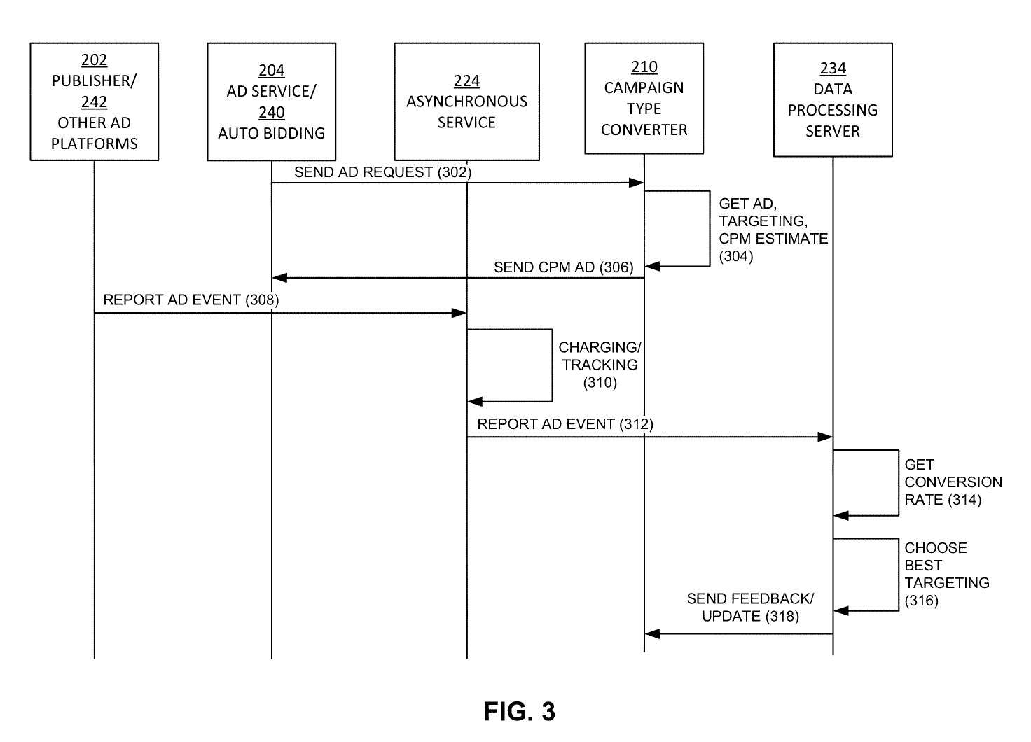

FIG. 3 illustrates an example flow diagram of the system 200 according to aspects described herein. At 302, an ad request may be transmitted from ad service 204 or auto bidding 240 to CPI converter 210. The ad request may include information about a potential viewer of an ad such as demographic information of the potential viewer, device information, advertisement size/dimensions, and advertisement type. Based on the potential viewer information, targeting selection module 216 can select the dimensions to target or target audience for the ad. Based on the target audience selected by targeting module 216, creative generator 212 can generate an ad corresponding to the selected target audience or dimensions, and CPM estimator 214 can calculate an estimated CPM value for the ad for the selected target audience.

At 306, CPI converter 210 can send the CPM advertisement generated by creative generator 212 to ad service 204 which can send the ad to publisher 202 and/or other ad platforms 242, and the estimated CPM value to auto bidding 240. The system 200 may wait until a bid price for the ad has been accepted before sending the CPM advertisement in an ad response

At 308, a publisher may report each event in the advertisement cycle. For example, the publisher may report the display of the ad (e.g., ad impression), a user clicking on the ad, and/or a user installing the advertised application on the computing device to asynchronous service 224. At 310, asynchronous service 224 may track the transaction using tracking module 226 and log the event using log module 232. Transactions module 228 may charge or debit the account of the advertiser for the accepted bid price of the advertisement and transfer the charged or debited amount to the account of the publisher. At 312, asynchronous service 224 may report the event or events of the ad to data processing server 234. At 314, data processing server 234 may use the reported information to update the conversion rate (e.g., CTR and/or IR) of ads in the campaign. At 316, data processing server can use the reported information to update and/or determine best target dimensions or audience for the advertisement in the campaign. At step 318, the updated conversion rate and/or target dimensions may be sent as feedback or an update to CPI converter 210. CPM estimator 214 can use the feedback to update the estimated CPM value for the campaign, and targeting selector 216 may consider the updated information in determining target dimensions for the campaign.

Aspects of the system and method described herein provide an end-to-end solution of automatically promoting a CPA/CPI campaign on a CPM/CPC advertisement platform. Aspects described herein further provide the ability to integrate different advertisement platforms and/or campaign types together and to automatically convert between different campaign types (e.g., CPI, CPA, CPC, CPM) while tracking all interactions with the ad (e.g., bidding, impression, click, installation, or other action) to provide advertisement statistics. Aspects of the disclosure can use the advertisement statistics to adjust bidding price and advertising strategies, select targeted audiences, and predict an estimated CPM value to maximize the return value of an ad.

While illustrative method steps have been described as being performed by a computing device, it is to be understood that the steps may be performed in a different order than described and may be performed by more than one computing device.

Although the subject matter has been described in language specific to structural features and/or methodological acts, it is to be understood that the subject matter defined in the appended claims is not necessarily limited to the specific features or acts described above. Rather, the specific features and acts described above are described as example implementations of the following claims.

What is claimed is:

1. A method, comprising:
receiving a request for an advertisement to display on a first computing device in a first campaign type, the request comprising potential viewer information;
in response to the request, determining, by one or more computing devices, an estimated advertisement value in a second campaign type for an advertising campaign based on at least one advertisement value in the first campaign type and an advertisement history of the advertising campaign;
determining, by the one or more computing devices, a bid price for the request based on the estimated advertisement value in the second campaign type; and
in response to receiving acceptance of the bid price, transmitting, by the one or more computing devices, an advertisement from the advertising campaign to the first computing device.

2. The method of claim 1, wherein the first campaign type is at least one of a cost-per-install (CPI) and a cost-per-acquisition (CPA) campaign type, the at least one advertisement value in the first campaign type comprises a CPI campaign price, and the advertising history comprises a click-through rate (CTR) of the advertising campaign and an install rate (IR) of the advertising campaign.

3. The method of claim 1, wherein the second campaign type is at least one of a cost-per-click (CPC) and a cost-per-mile (CPM) campaign type.

4. The method of claim 1, wherein determining the estimated advertisement value in the second campaign type comprises:
determining the estimated advertisement value based on a normal distribution function N(μ, σ), where μ=an average CPM value (aCPM) and σ=0.1*aCPM.

5. The method of claim 1, wherein determining the estimated advertisement value in the second campaign type comprises:
determining an average CPM value (aCPM) according to:
aCPM=10³*(α*CTR*IR*CPI+βΣ(η(i)*d(i))),
where: α+β=1,
α and β=manually adjusted weights,
CTR=click-through rate of the advertising campaign,
IR=install rate of the advertising campaign,
CPI=cost-per-install price for the advertising campaign
d(i)=ith dimension value, and
η(i)=weighting for the ith dimension.

6. The method of claim 5, further comprising:
determining a click transfer rate (CTR), an install rate (IR), and a cost-per-install (CPI) based on the advertising history of the advertising campaign.

7. The method of claim 1, further comprising:
automatically bidding for an advertisement for the advertising campaign based on the estimated advertisement value.

8. A system, comprising:
one or more processors, and
one or more memories storing instructions that, when executed by the one or more processors, configure one or more computing devices to perform:
receiving a request for an advertisement to display on a first computing device in a first campaign type, the request comprising potential viewer information;
in response to the request, determining, by the one or more computing devices, an estimated advertisement value in a second campaign type for an advertising campaign based on at least one advertisement value in the first campaign type and an advertisement history of the advertising campaign;
determining, by the one or more computing devices, a bid price for the request based on the estimated advertisement value in the second campaign type; and
in response to receiving acceptance of the bid price, transmitting, by the one or more computing devices, an advertisement from the advertising campaign to the first computing device.

9. The system of claim 8, wherein the first campaign type is at least one of a cost-per-install (CPI) and a cost-per-acquisition (CPA) campaign type, the at least one advertisement value in the first campaign type comprises a CPI campaign price, and the advertising history comprises a click-through rate (CTR) of the advertising campaign and an install rate (IR) of the advertising campaign.

10. The system of claim 8, wherein the second campaign type is at least one of a cost-per-click (CPC) and a cost-per-mile (CPM) campaign type.

11. The system of claim 8, wherein determining the estimated advertisement value in the second campaign type comprises:
determining the estimated advertisement value based on a normal distribution function N(μ, σ), where μ=an average CPM value (aCPM) and σ=0.1*aCPM.

12. The system of claim 8, wherein determining the estimated advertisement value in the second campaign type comprises:
determining an average CPM value (aCPM) according to:
aCPM=10³*(α*CTR*IR*CPI+βΣ(η(i)*d(i))),
where: α+β=1,
α and β=manually adjusted weights,
CTR=click-through rate of the advertising campaign,
IR=install rate of the advertising campaign,
CPI=cost-per-install price for the advertising campaign
d(i)=ith dimension value, and
η(i)=weighting for the ith dimension.

13. The system of claim 12, wherein the one or more memories further store instructions that, when executed by the one or more processors, configure one or more computing devices to perform:
determining a click transfer rate (CTR), an install rate (IR), and a cost-per-install (CPI) based on the advertising history of the advertising campaign.

14. The system of claim 8, wherein the one or more memories further store instructions that, when executed by the one or more processors, configure one or more computing devices to perform:
automatically bidding for an advertisement for the advertising campaign based on the estimated advertisement value.

15. One or more non-transitory computer-readable storage media storing computer-executable instructions that, when executed by one or more processors of a data processing system, cause the system to perform:
receiving a request for an advertisement to display on a first computing device in a first campaign type, the request comprising potential viewer information;
in response to the request, determining, by one or more computing devices, an estimated advertisement value in a second campaign type for an advertising campaign based on at least one advertisement value in the first campaign type and an advertisement history of the advertising campaign;
determining, by the one or more computing devices, a bid price for the request based on the estimated advertisement value in the second campaign type; and
in response to receiving acceptance of the bid price, transmitting, by the one or more computing devices, an advertisement from the advertising campaign to the first computing device.

16. The computer-readable storage media of claim 15, wherein the first campaign type is at least one of a cost-per-install (CPI) and a cost-per-acquisition (CPA) campaign type, the at least one advertisement value in the first campaign type comprises a CPI campaign price, and the advertising history comprises a click-through rate (CTR) of the advertising campaign and an install rate (IR) of the advertising campaign.

17. The computer-readable storage media of claim 15, wherein the second campaign type is at least one of a cost-per-click (CPC) and a cost-per-mile (CPM) campaign type.

18. The computer-readable storage media of claim 15, wherein determining the estimated advertisement value in the second campaign type comprises:
determining the estimated advertisement value based on a normal distribution function N(μ, σ), where μ=an average CPM value (aCPM) and σ=0.1*aCPM.

19. The computer-readable storage media of claim 15, wherein determining the estimated advertisement value in the second campaign type comprises:
determining an average CPM value (aCPM) according to:
aCPM=10³*(α*CTR*IR*CPI+βΣ(η(i)*d(i))),
where: α+β=1,
α and β=manually adjusted weights,
CTR=click-through rate of the advertising campaign,
IR=install rate of the advertising campaign,
CPI=cost-per-install price for the advertising campaign
d(i)=ith dimension value, and
η(i)=weighting for the ith dimension.

20. The computer-readable storage media of claim 19, wherein media further stores computer-executable instructions that, when executed by one or more processors of a data processing system, cause the system to perform:
determining a click transfer rate (CTR), an install rate (IR), and a cost-per-install (CPI) based on the advertising history of the advertising campaign; and
automatically bidding for an advertisement for the advertising campaign based on the estimated advertisement value.
